(19) United States
(12) Patent Application Publication
(10) Pub. No.: US 2026/0322175 A1
(43) Pub. Date: Oct. 15, 2026

(54) WIRELESS POWER SUPPLY DEVICE

(71) Applicant: Mitsubishi Electric Corporation, Tokyo (JP)

(72) Inventor: Takuya NAKANISHI, Tokyo (JP)

(73) Assignee: Mitsubishi Electric Corporation, Tokyo (JP)

(21) Appl. No.: 19/481,388

(22) PCT Filed: May 26, 2023
(86) PCT No.: PCT/JP2023/019647

§ 371 Date: Nov. 4, 2025

(51) Int. Cl. H02J 50/50; H02J 50/12

(52) U.S. Cl. CPC H02J 50/50; H02J 50/12

(57) ABSTRACT

A wireless power supply device includes a plurality of intermediate power transmitting/receiving devices which receive power and supply the received power to connected loads and which each transmit power to a next one of the transmitting/receiving devices. Each of the plurality of intermediate power transmitting/receiving devices has a power receiving device for receiving power and a power transmitting device capable of transmitting power. A voltage control device for causing voltage at each of the intermediate power transmitting/receiving devices to fall within a fixed range regardless of the loads is connected at a stage subsequent to the power receiving device. Thus, each load voltage can be controlled to fall within a predetermined range, whereby the efficiency is improved.

### TECHNICAL FIELD

The present disclosure relates to a wireless power supply device.

### BACKGROUND ART

There is a magnetic field coupling wireless power supply technology in which power is transferred wirelessly via a magnetic field. In this magnetic field coupling wireless power supply technology, a technique of connecting a plurality of wireless power supply devices in a multistage manner by using relay devices and sequentially transferring power has been known (for example, see Patent Document 1).

### CITATION LIST

### Patent Document

Patent Document 1: Japanese Patent No. 6681574

### SUMMARY OF THE INVENTION

### Problem to be Solved by the Invention

In a system of sequentially performing wireless power supply by using a plurality of relay devices, it is required to perform control through which desirable voltage and power supply can be attained at each of the relay devices. However, when power is received as alternating current (AC) for control, is converted into direct current (DC), and is re-converted into AC for power transmission, the device configuration becomes complicated, resulting in increase in the number of components and in increase in loss.

The present disclosure has been made to solve the above problem, and an object of the present disclosure is to provide a wireless power supply device which can control each load voltage to fall within a predetermined range without re-converting DC into AC at each intermediate power transmitting/receiving device, whereby the efficiency is improved.

### Means to Solve the Problem

A wireless power supply device according to the present disclosure includes a plurality of intermediate power transmitting/receiving devices which receive power and supply the received power to connected loads and which each transmit power to a next one of the power transmitting/receiving devices. Each of the plurality of intermediate power transmitting/receiving devices has a power receiving device for receiving power and a power transmitting device capable of transmitting power. A voltage control device for causing voltage at each of the intermediate power transmitting/receiving devices to fall within a fixed range regardless of the loads is connected at a stage subsequent to the power receiving device.

### Effect of the Invention

The wireless power supply device according to the present disclosure can control each load voltage to fall within a predetermined range without re-converting DC into AC at each intermediate power transmitting/receiving device, whereby the efficiency is improved.

### BRIEF DESCRIPTION OF THE DRAWINGS

FIG. 1 shows an overall view of a wireless power supply device according to embodiment 1.

FIG. 2 illustrates a configuration of an intermediate power transmitting/receiving device according to embodiment 1.

FIG. 3 illustrates the disposition of a plurality of the intermediate power transmitting/receiving devices according to embodiment 1.

FIG. 4 illustrates a configuration of a final stage of the intermediate power transmitting/receiving devices according to embodiment 1.

FIG. 5 illustrates a coupling coefficient and inductances of respective coils of the intermediate power transmitting/receiving devices according to embodiment 1.

FIG. 6 illustrates an operation of the wireless power supply device according to embodiment 1.

FIG. 7 illustrates ON and OFF of semiconductor switches of an AC output power source according to embodiment 1.

FIG. 8 shows one example of an output voltage waveform during switching operation of the semiconductor switches in FIG. 7.

FIG. 9 illustrates the disposition of a current detection unit of the AC output power source according to embodiment 1.

FIG. 10 is a flowchart illustrating an operation in an all-no-load state of the wireless power supply device according to embodiment 1.

FIG. 11 illustrates a phase difference between current and voltage in FIG. 10.

FIG. 12 shows a configuration of a comparative example 1.

FIG. 13 shows a configuration of a comparative example 2.

FIG. 14 shows a configuration of a comparative example 3.

FIG. 15 shows a range to be converted into an equivalent circuit for explaining an effect of the intermediate power transmitting/receiving devices according to embodiment 1.

FIG. 16 shows an equivalent circuit diagram corresponding to the range in FIG. 15.

FIG. 17 illustrates a configuration of multistage connection of the intermediate power transmitting/receiving devices according to embodiment 1.

FIG. 18 shows a schematic configuration of an AC output power source and a plurality of intermediate power transmitting/receiving devices according to embodiment 2.

FIG. 19 is a flowchart illustrating an operation in an all-no-load state of a wireless power supply device according to embodiment 2.

FIG. 20 shows one example of hardware of a controller according to embodiments 1 and 2.

### DESCRIPTION OF EMBODIMENTS

Hereinafter, a wireless power supply device according to preferred embodiments of the present disclosure will be described with reference to the drawings. It is noted that the same components and corresponding parts are denoted by the same reference characters, and detailed description thereof will be omitted. Also in the other embodiments, the constituents denoted by the same reference characters will not be repetitively described.

### Embodiment 1

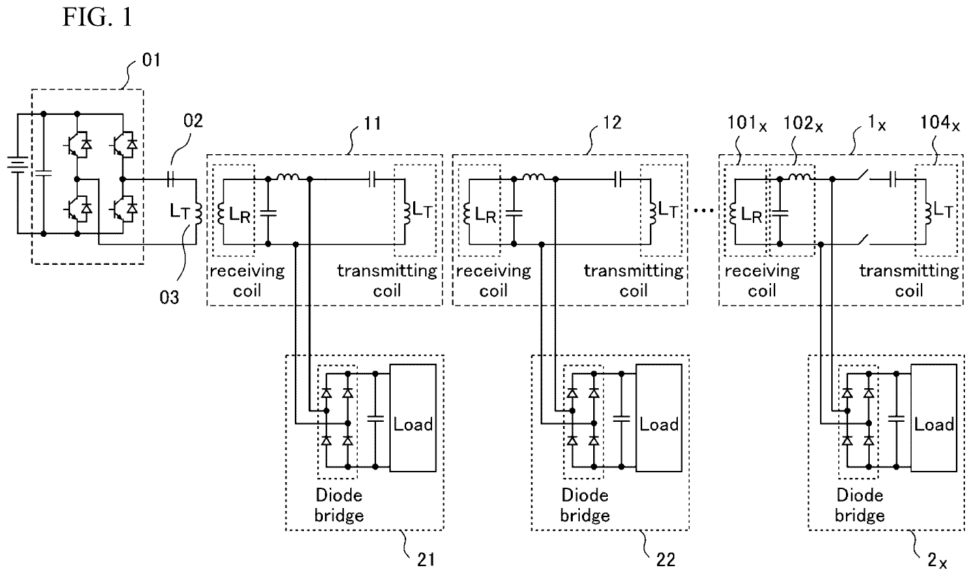

The basic configuration of the present embodiment will be described. FIG. 1 is an overall view illustrating the basic configuration of a wireless power supply device according to embodiment 1.

### <AC Output Power Source and Transmitting Coils>

The present embodiment is configured by an AC output power source 01 that converts DC power into AC power and outputs the AC power, a resonance module 02 that is directly connected to the AC output power source 01, a first transmitting coil 03, a plurality of intermediate power transmitting/receiving devices 11, 12, . . . 1ₓ, and a plurality of load devices 21, 22, . . . 2ₓ. In FIG. 1, the AC output power source 01 is configured as a full bridge inverter. The type of semiconductor switches is not limited. In addition, the switch configuration is not necessarily the full bridge configuration as long as DC-AC conversion can be performed.

The resonance module 02 is composed of a capacitor. FIG. 1 shows, as the simplest configuration, the configuration in which the capacitor is connected in series to the first transmitting coil 03, but other configurations may be adopted.

### <Intermediate Power Transmitting/Receiving Devices>

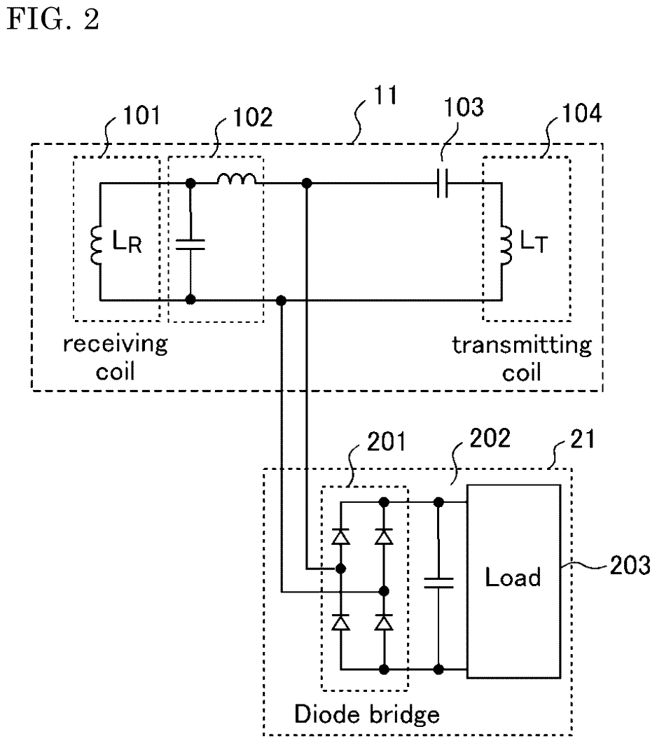

Among the plurality of intermediate power transmitting/receiving devices 11 to 1ₓ, the intermediate power transmitting/receiving devices 11 to 1x-1 have the same configuration. FIG. 2 shows a configuration example of the intermediate power transmitting/receiving device 11. The intermediate power transmitting/receiving device 11 is composed of a receiving coil 101, a voltage control module 102, a resonance capacitor 103, a transmitting coil 104, and a load device 21. The voltage control module 102 is connected at a stage subsequent to the receiving coil 101. At a stage subsequent to the voltage control module 102, the load device 21 and a circuit composed of the transmitting coil 104 and the resonance capacitor 103 are connected in parallel. The resonance capacitor 103 and the transmitting coil 104 are connected in series.

The voltage control module 102 in the intermediate power transmitting/receiving device 11 is composed of a set of a capacitor and an inductor. The capacitor is connected in parallel to the receiving coil 101 and the inductor is connected in series to the parallel connection configuration of the capacitor and the receiving coil 101. It is not necessary to adopt the above-described configuration example as long as the relationship described in <Setting of Intermediate Power Transmitting/Receiving Devices>, which is described later, is satisfied.

In the load device 21, a smoothing capacitor 202 is connected at a stage subsequent to a rectifying diode bridge 201, and a load 203 is connected at a stage subsequent to the capacitor 202. The load 203 may be an inverter, a motor, or various kinds of load equipment such as lighting. It is noted that, although not shown in FIG. 1, a current detection unit 71 is connected to the AC output power source 01 for the purpose of detecting current, as shown in FIG. 9 described later.

### <Disposition of Plurality of Intermediate Power Transmitting/Receiving Devices>

The intermediate power transmitting/receiving devices 11 to 1ₓ are configured and disposed as follows. The receiving coil 101 of the intermediate power transmitting/receiving device 11 is disposed close to the first transmitting coil 03 to be magnetically coupled. The receiving coil 101 of the intermediate power transmitting/receiving device 12 is disposed close to the transmitting coil 104 of the intermediate power transmitting/receiving device 11 to be magnetically coupled. The intermediate power transmitting/receiving devices 13 to 1ₓ are configured in the similar disposition.

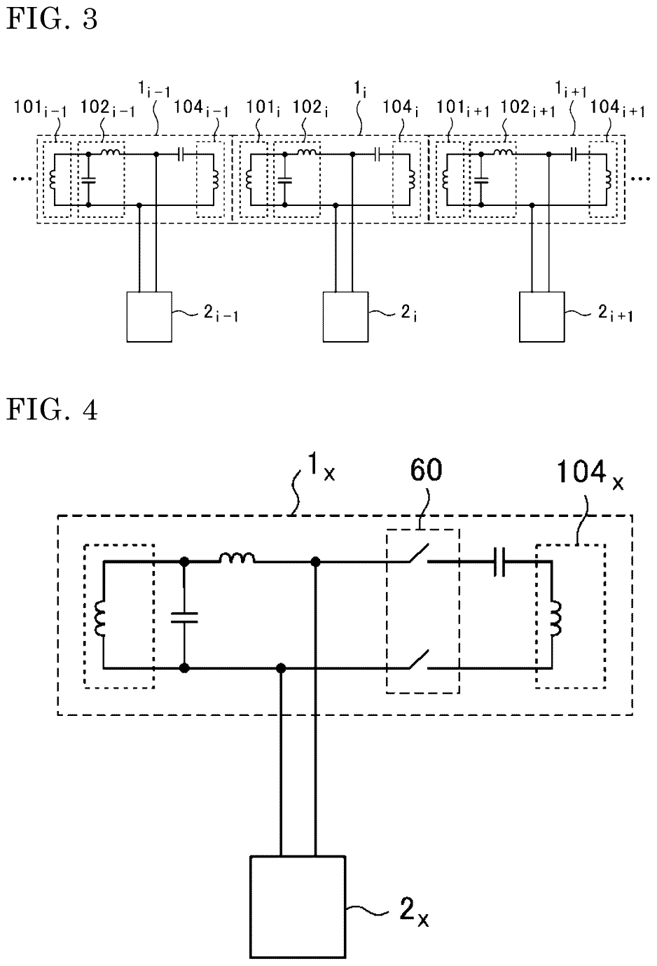

FIG. 3 shows the disposition of intermediate power transmitting/receiving devices 1ᵢ₋₁ to 1ᵢ₊₁, which correspond to the intermediate power transmitting/receiving device 13 and subsequent thereto. A receiving coil 101ᵢ of the intermediate power transmitting/receiving device 1ᵢ is disposed close to a transmitting coil 104ᵢ₋₁ of the (i−1)th intermediate power transmitting/receiving device 1ᵢ₋₁, and a transmitting coil 104ᵢ of the ith intermediate power transmitting/receiving device 1ᵢ is disposed close to a receiving coil 101ᵢ₊₁ of the (i+1)th intermediate power transmitting/receiving device 1ᵢ₊₁.

FIG. 4 shows the intermediate power transmitting/receiving device 1ₓ disposed at the final stage. The intermediate power transmitting/receiving device 1ₓ has a circuit 60 which brings a transmitting coil 104ₓ part into an open-circuit state by disconnecting a power transmitting device at a stage subsequent to the voltage control device, or by being open-circuited.

### <Setting of Intermediate Power Transmitting/Receiving Devices>

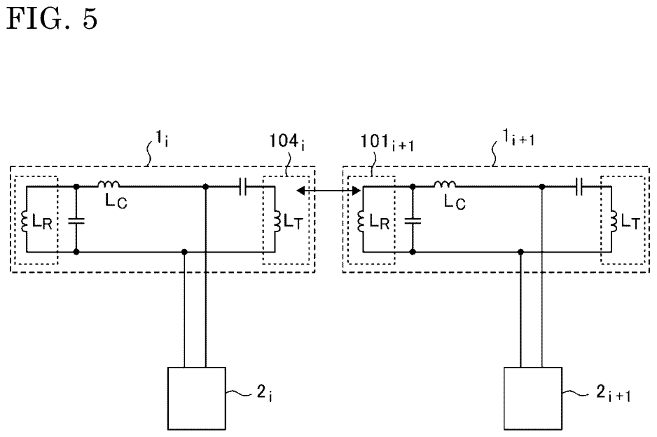

FIG. 5 shows a coupling coefficient and inductances of respective coils of the intermediate power transmitting/receiving devices 1ᵢ, 1ᵢ₊₁.

A value obtained by multiplying “the reciprocal of a coupling coefficient k between the transmitting coil 104; and the receiving coil 102ᵢ₊₁” by “the square root of the quotient of an inductance value L_{R} of the receiving coil 102ᵢ₊₁ divided by an inductance value L_{T} of the transmitting coil 104ᵢ” is close to 1, and an inductance value Lc of the voltage control device 1ᵢ₊₁ is substantially equal to the inductance value L_{R} of the receiving coil 102ᵢ₊₁. The reason for this configuration will be described in detail in <Explanation of Reason Why Voltage Control Module Exhibits Effect> described later.

### <Operation of Wireless Power Supply Device>

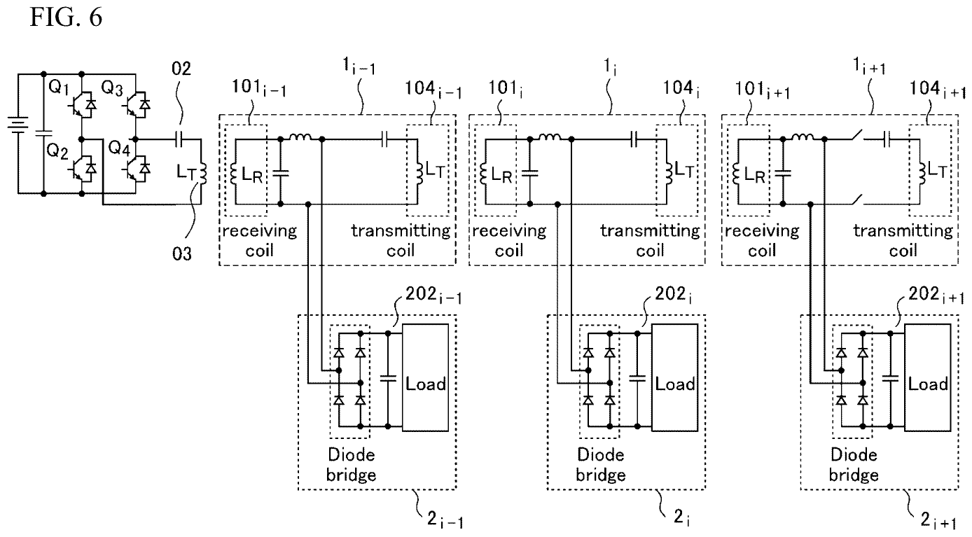

Next, an operation of the present device will be described. In explanation of an operation example, if the number of the intermediate power transmitting/receiving devices is indefinite, description is complicated. Therefore, as shown in FIG. 6, a case of using three intermediate power transmitting/receiving devices 1ᵢ₋₁, 1ᵢ, 1ᵢ₊₁ will be described. The load devices 2ᵢ₋₁ to 2ᵢ₊₁ are respectively connected to the intermediate power transmitting/receiving devices 1ᵢ₋₁ to 1ᵢ₊₁. It is noted that the basic operation is the same even if the number of the intermediate power transmitting/receiving devices increases/decreases.

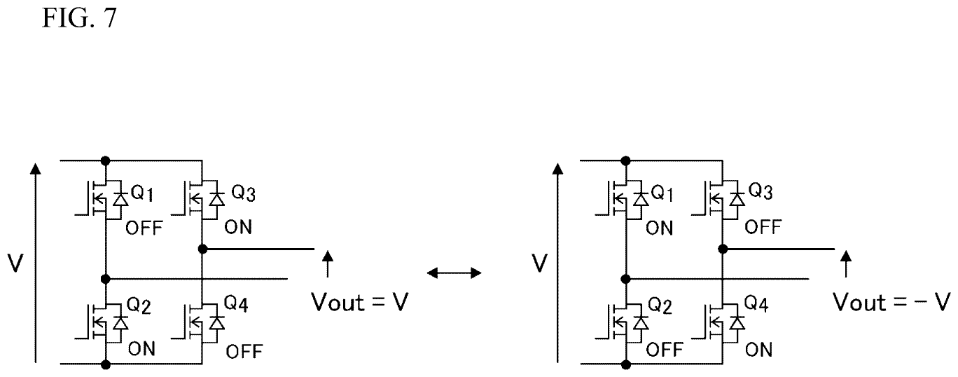

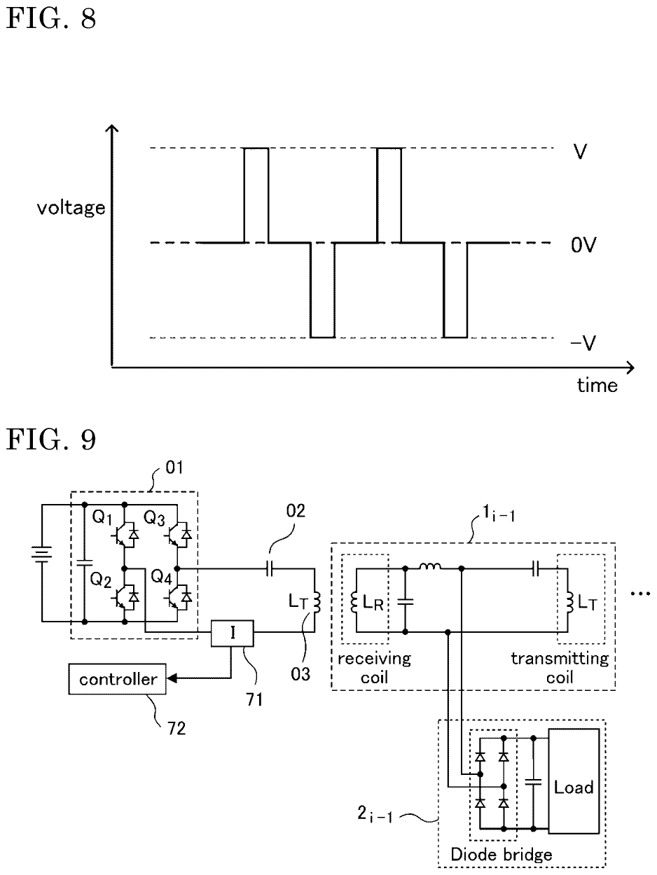

First, a power inputting start sequence is initiated. All of the three load devices 2ᵢ₋₁ to 2ᵢ₊₁ are in a no-load state at startup. Meanwhile, since an electric charge is not stored in capacitors 202ᵢ₋₁ to 202ᵢ₊₁ of the load devices 2ᵢ₋₁ to 2ᵢ₊₁, active power is supplied in operation in order to charge the capacitors 202ᵢ₋₁ to 202ᵢ₊₁.
(1) Semiconductor switches Q1 to Q4 of the AC output power source 01 are turned on/off at a predetermined frequency. That is, the switches are turned on or off for each diagonal set as shown in FIG. 7. Such an operation generates output voltage as shown in FIG. 8, for example. This is a typical switching operation of a full bridge inverter. This may be realized by phase shift or by pulse width modulation (PWM).
(2) DC voltage V is inputted, and the state in which the semiconductor switches Q1 and Q4 are turned off and the semiconductor switches Q2 and Q3 are turned on and the state in which the semiconductor switches Q1 and Q4 are turned on and the semiconductor switches Q2 and Q3 are turned off are repeated at a predetermined frequency. Thus, AC voltage Vout is outputted from the AC output power source 01.
(3) With this operation, AC power is supplied to the resonance module 02 and the first transmitting coil 03. When AC current flows through the first transmitting coil 03, a magnetic field is generated around the first transmitting coil 03.
(4) With this magnetic field interlinking the receiving coil 101ᵢ₋₁ of the intermediate power transmitting/receiving device 1ᵢ₋₁, an induced electromotive force is generated at the receiving coil 101ᵢ₋₁, whereby current flows. The current generated here passes through the voltage control module 102ᵢ₋₁, to charge the capacitor 202ᵢ₋₁ of the load device 2ᵢ₋₁.
(5) Simultaneously, current is supplied to the transmitting coil 104ᵢ₋₁ of the intermediate power transmitting/receiving device 1ᵢ₋₁. Thus, a magnetic field is generated around the transmitting coil 104ᵢ₋₁.
(6) With this magnetic field interlinking the receiving coil 101ᵢ of the intermediate power transmitting/receiving device 1ᵢ, an induced electromotive force is generated at the receiving coil 101ᵢ, whereby current flows. The current generated here passes through the voltage control module 102ᵢ, to charge the capacitor 202ᵢ of the load device 2ᵢ connected to the intermediate power transmitting/receiving device 1_{i.}
(7) Simultaneously, current is supplied to the transmitting coil 104ᵢ of the intermediate power transmitting/receiving device 1ᵢ. Thus, AC current flows through the transmitting coil 104ᵢ, whereby a magnetic field is generated around the transmitting coil 104ᵢ.
(8) With this magnetic field interlinking the receiving coil 101ᵢ₊₁ of the intermediate power transmitting/receiving device 1ᵢ₊₁, an induced electromotive force is generated at the receiving coil 101ᵢ₊₁, whereby current flows. The current generated here passes through the voltage control module 102ᵢ₊₁, to charge the capacitor 202ᵢ₊₁ of the load device 2ᵢ₊₁ connected to the intermediate power transmitting/receiving device 1ᵢ₊₁.
(9) Here, upon reaching a predetermined voltage, each of the load devices 2ᵢ₋₁ to 2ᵢ₊₁ starts and power is supplied. It is noted that this operation provides substantially the same input voltage to the load devices 2ᵢ₋₁ to 2ᵢ₊₁ of the present embodiment.
(10) When the intermediate power transmitting/receiving device 2ᵢ₊₁ is at the final stage 1ₓ, the path to the transmitting coil 104ₓ is open-circuited by the circuit 60 shown in FIG. 4.

### <All-No-Load Condition>

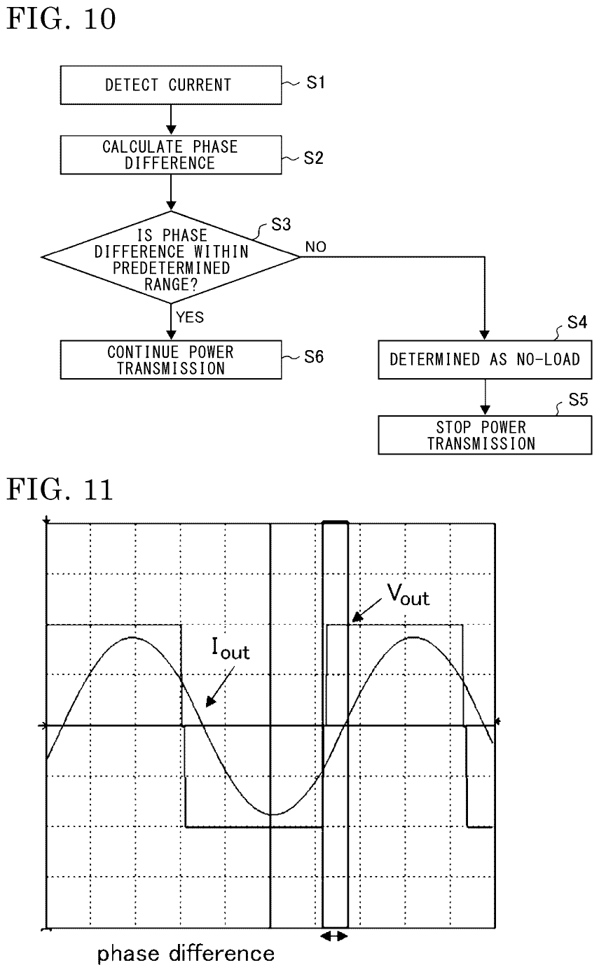

During operation, there is a possibility that all of the load devices 2ᵢ₋₁ to 2ᵢ₊₁ go into a substantially no-load or significantly low-load state. In such a case, in order to prevent excessive increase of voltage at each of the intermediate power transmitting/receiving devices 1ᵢ₋₁ to 1ᵢ₊₁, the following operation is performed. FIG. 9 shows the AC output power source 01, which is a full bridge inverter, including the current detection unit 71, and the intermediate power transmitting/receiving device 1ᵢ₋₁. Current detected by the current detection unit 71 is inputted in a controller 72, and the controller 72 controls the AC output power source 01. FIG. 10 shows the flowchart.
(1) Current at the current detection unit 71 is detected (step S1 in FIG. 10). The phase difference (phase difference in FIG. 11) between voltage and current at the transmitting coils 104ᵢ₋₁ to 104ᵢ₊1 is constantly monitored (step S2). When the phase difference is greater than a predetermined value and exceeds a predetermined range (step S3, No), the load state is determined to be a no-load or significantly low-load state (step S4), and power supply is stopped (step S5), or an operation such as reducing output voltage is performed by phase shift control.
(2) In addition, even after the phase difference exceeds the predetermined range, power supply is performed at a predetermined timing. If the phase difference is within the predetermined range (step S3, Yes), power supply is again continuously performed (step S6), and if the phase difference is outside the predetermined range, it is determined that the no-load state has been continued, and power supply is not performed (step S5).
   <Explanation of Superiority and Effect Through Comparison with Configurations of Comparative Examples>

Here, the reasons why the configuration of the present embodiment is effective compared to comparative examples 1 to 3 will be described.

### Comparative Example 1

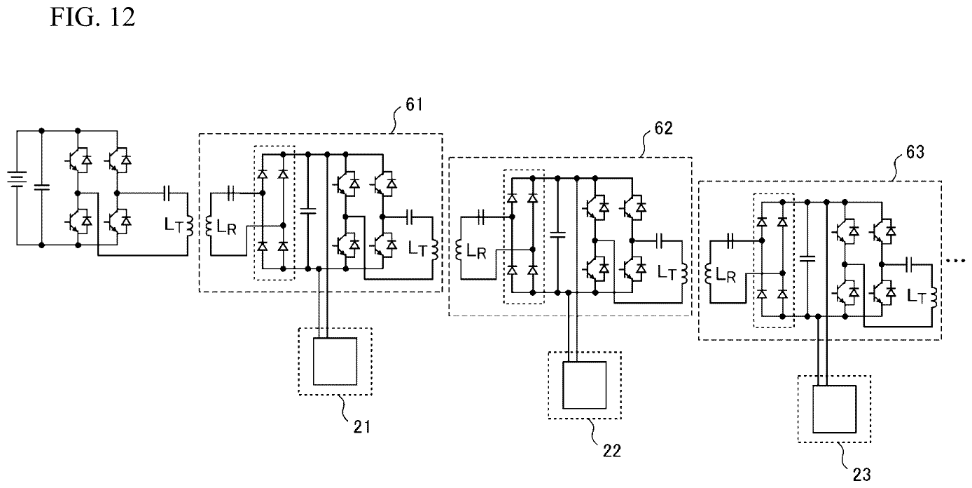

In a comparative example 1, as shown in FIG. 12, a configuration in which power received in an intermediate power transmitting/receiving device is once converted into DC, and then re-converted into AC, is assumed. In FIG. 12, three intermediate power transmitting/receiving devices 61 to 63 are shown for the purpose of simplification. Inside each of the intermediate power transmitting/receiving devices 61 to 63, means (AC-DC-AC conversion means) for conversion from AC to DC and from DC to AC is disposed. The load devices 21 to 23 are respectively connected to the intermediate power transmitting/receiving devices 61 to 63.

This configuration of the comparative example 1 has an advantage of being capable of constantly controlling voltage supply at each of the stages of the intermediate power transmitting/receiving devices 61 to 63 regardless of a device configuration. Meanwhile, since conversion from AC to DC and from DC to AC is performed, loss occurs and the loss increases as the number of connection increases. In addition, since the AC-DC-AC conversion is performed, an inverter, a semiconductor switch constituting the inverter, a control circuit for driving the semiconductor switch, etc., are needed for each of the intermediate power transmitting/receiving devices 61 to 63, thus resulting in increase in cost and device size.

### Comparative Example 2

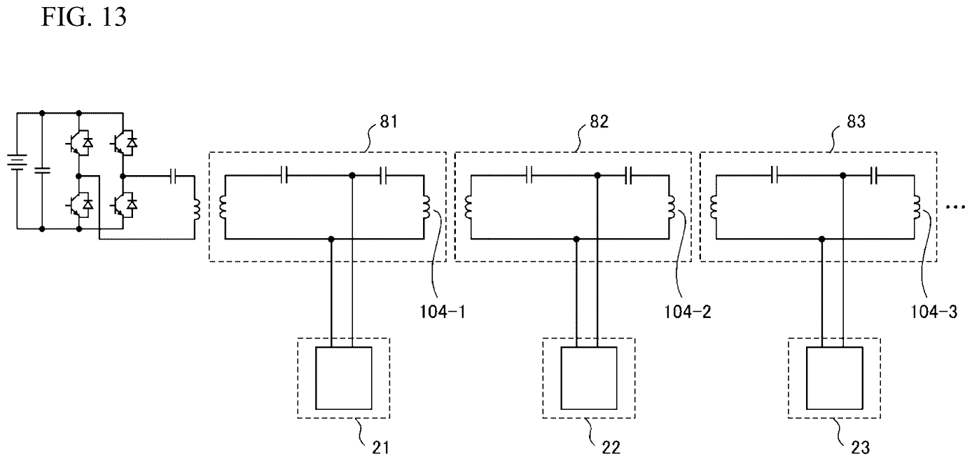

Meanwhile, FIG. 13 shows a configuration in which power is supplied from a receiving coil to the next transmitting coil by using AC as it is without performing AC-DC-AC conversion. In FIG. 13, three intermediate power transmitting/receiving devices 81 to 83 are shown for the purpose of simplification. The intermediate power transmitting/receiving devices 81 to 83 do not perform AC-DC-AC conversion. The load devices 21 to 23 are respectively connected to the intermediate power transmitting/receiving devices 81 to 83.

This is a configuration in which the load devices 21 to 23 are connected in parallel to a series-resonance-type wireless power supply configuration. In this configuration, it is possible to connect wireless power supply in a multistage manner and perform power supply. However, voltage applied to each of the transmitting coils 104-1 to 104-3 of the intermediate power transmitting/receiving devices 81 to 83 can significantly vary depending on the power consumption of the load devices 21 to 23 connected to the intermediate power transmitting/receiving devices 81 to 83. Voltages at the next and subsequent stages in connection of three or more devices can further vary, making it impossible to realize wireless power supply to each load at an appropriate voltage.

That is, even when power can be supplied appropriately in a certain condition, if the power consumption of any one of the load devices 21 to 23 varies, the entire connected stages are affected. This problem is caused by pseudo current source characteristics in a series-resonance-type wireless power supply system. Since constant current flows to the load side until exceeding a certain range, when the impedance of the load in the load devices 21 to 23 varies, the voltage varies. The voltage variation changes the output voltage of the next stage. That is, it is impossible, in principle, to realize constant voltage (or to cause voltage to fall within a fixed range) over all the stages of the intermediate power transmitting/receiving devices.

### Comparative Example 3

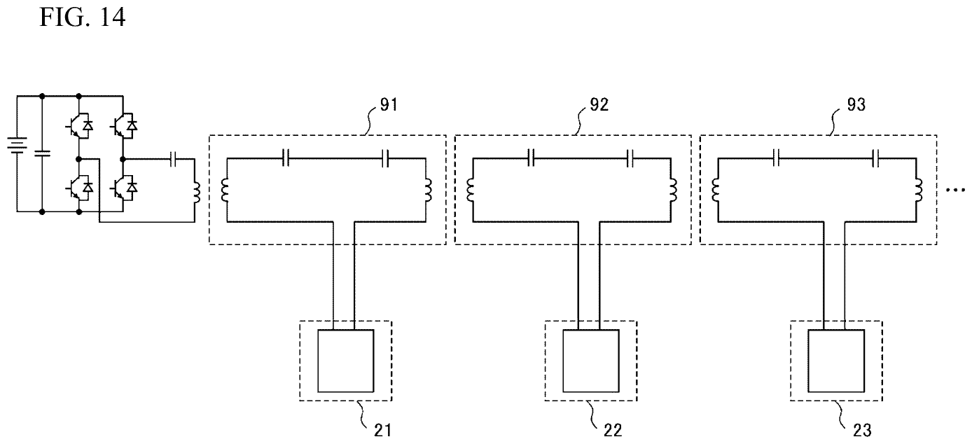

In addition, FIG. 14 shows a configuration example in which the load devices 21 to 23 are connected in series to a series-resonance-type wireless power supply configuration. In FIG. 14, three intermediate power transmitting/receiving devices 91 to 93 are shown for the purpose of simplification. As in the comparative example 2, the intermediate power transmitting/receiving devices 91 to 93 do not perform AC-DC-AC conversion. When the load devices 21 to 23 are respectively connected in series to the transmitting coils and the receiving coils of the intermediate power transmitting/receiving devices 91 to 93, owing to the pseudo current source characteristics of the series connection in the wireless power supply system, the influence to vary on applied voltage (current) of the transmitting coils due to variation of load power consumption, is reduced. However, with this configuration, if any one of the load devices 21 to 23 goes into a no-load state or a low-load state close to a no-load state, it becomes impossible to supply power. In a state close to a no-load state, i.e., the state where the effective resistance value of each of the load devices 21 to 23 is great, resonance characteristics are no longer available, and thus the current source characteristics are not maintained. In addition, even if the current source characteristics are maintained, the applied voltage across the load device becomes excessive, thus lacking practicality. When a load resistance value increases while current is constant, voltage increases.

As compared to the comparative examples 1 to 3, in the configuration according to embodiment 1 shown in FIG. 1, the voltage control modules 102 to 102ₓ are connected at stages subsequent to the receiving coils 101 to 101ₓ of the intermediate power transmitting/receiving devices 11 to 1ₓ, and the load devices 21 to 2ₓ and the transmitting coils 104 to 104ₓ are respectively connected in parallel, thereby solving all of the aforementioned problems of the comparative examples 1 to 3. With such a configuration, AC-DC-AC conversion for each of the intermediate power transmitting/receiving devices 11 to 1ₓ is eliminated, thus making it possible to reduce loss and to reduce the device size and the number of components.

In addition, voltages applied to the transmitting coils 104 to 104ₓ can be made constant regardless of the power consumption of the load devices 21 to 2ₓ. Essentially, this configuration entails the problem that the voltage increases in a case where power consumption is small. However, by adopting such a contiguous-connection-type configuration, even when there is no power consumption at a certain intermediate power transmitting/receiving device, as long as any intermediate power transmitting/receiving device and any load device consume power, voltages at the intermediate power transmitting/receiving devices can be made substantially constant. That is, this configuration is adaptive to the no-load state of the load devices.

As an exception to the above, voltage increase may happen if all of the load devices go into the no-load state. However, this can also be controlled through detection of a phase difference between voltage and current on the AC output power source 01 side by the aforementioned method.

### <Explanation of Reason Why Voltage Control Module Exhibits Effect>

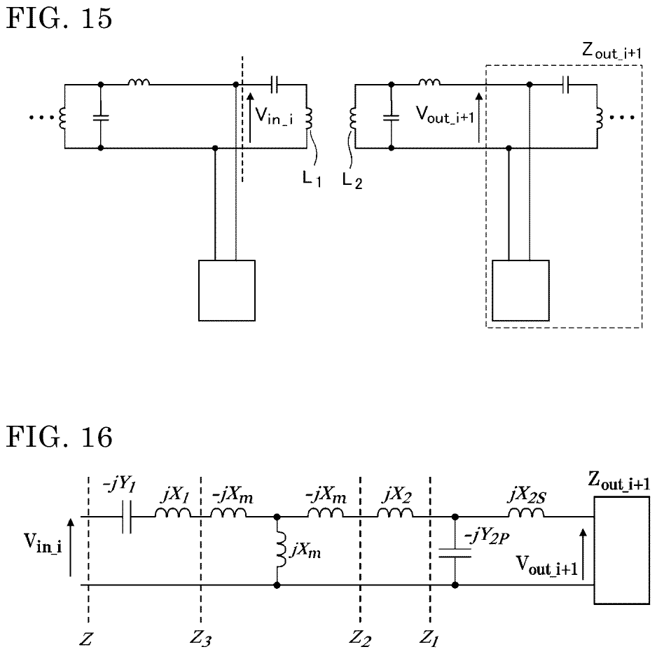

Here, the reason why the configuration of the voltage control module 102 can exhibit an effect will be described by using an equivalent circuit and mathematical formulae. First, an equivalent circuit of a pair of the intermediate power transmitting/receiving devices 1ᵢ, 1ᵢ₊₁ is assumed. This may be assumed as a part between the intermediate power transmitting/receiving device 11, and the first transmitting coil 03 and the resonance module 02. FIG. 15 shows a part corresponding to the part to be converted into the equivalent circuit. A region after the voltage control module is collectively denoted as Z_{out_i+1}. FIG. 16 shows the equivalent circuit of the corresponding part in FIG. 15. Here, the impedances are denoted as Z₁, Z₂, Z₃, and Z. Each of the impedances is determined as follows.

### [Mathematical 1]

$$\begin{matrix}{Z}_{1} = \frac{- {jY}_{2 P} ( {jX}_{2 S} + {Z}_{out \_ i + 1} )}{{jX}_{2 S} + {Z}_{out \_ i + 1} - {jY}_{2 P}} \\ = \frac{- {jY}_{2 P} ( {jX}_{2 S} + {Z}_{out \_ i + 1} ) \{ {Z}_{out \_ i + 1} - j ( {X}_{2 S} - {Y}_{2 P} ) \}}{{Z}_{out \_ i + 1}^{2} + {( {X}_{2 S} - {Y}_{2 P} )}^{2}} \\ = \frac{{Z}_{out \_ i + 1} {Y}_{2 P}^{2}}{{Z}_{out \_ i + 1}^{2} + {( {X}_{2 S} - {Y}_{2 P} )}^{2}} - j \{ \frac{{Z}_{{out}_{i} + 1}^{2} + {X}_{2 S} ( {X}_{2 S} - {Y}_{2 P} )}{{Z}_{{out}_{i} + 1}^{2} + {( {X}_{2 S} - {Y}_{2 P} )}^{2}} \} {Y}_{2 P} \\ = \frac{{Z}_{out \_ i + 1} {Y}_{2 P}^{2}}{{Z}_{out \_ i + 1}^{2} + {β}^{2}} - j \{ \frac{{Z}_{{out}_{i} + 1}^{2} + {X}_{2 S} β}{{Z}_{{out}_{i} + 1}^{2} + {β}^{2}} \} {Y}_{2 P}\end{matrix} \qquad ( 1 )$$

$$where$$

$$β = ( {X}_{2 S} - {Y}_{2 P} )$$

### [Mathematical 2]

$$\begin{matrix}{Z}_{2} = {jX}_{2} + {Z}_{1} \\ = {jX}_{2} + \frac{{Z}_{out \_ i + 1} {Y}_{2 P}^{2}}{{Z}_{out \_ i + 1}^{2} + {β}^{2}} - j \{ \frac{{Z}_{{out}_{i} + 1}^{2} + {X}_{2 S} β}{{Z}_{{out}_{i} + 1}^{2} + {β}^{2}} \} {Y}_{2 P} \\ = \frac{{Z}_{out \_ i + 1} {Y}_{2 P}^{2}}{{Z}_{out \_ i + 1}^{2} + {β}^{2}} + {jX}_{2} - j \{ \frac{{Z}_{{out}_{i} + 1}^{2} + {X}_{2 S} β}{{Z}_{{out}_{i} + 1}^{2} + {β}^{2}} \} {Y}_{2 P} \\ = \frac{{Z}_{out \_ i + 1} {Y}_{2 P}^{2}}{{Z}_{out \_ i + 1}^{2} + {β}^{2}} + j ( {X}_{2} - {Y}_{2 P} ) - j \{ \frac{( {X}_{2 S} + β ) β}{{Z}_{{out}_{i} + 1}^{2} + {β}^{2}} \} {Y}_{2 P} \\ = \frac{{Z}_{out \_ i + 1} {Y}_{2 P}^{2}}{{Z}_{out \_ i + 1}^{2} + {β}^{2}} + j α - j \{ \frac{( {X}_{2 S} + β ) β}{{Z}_{{out}_{i} + 1}^{2} + {β}^{2}} \} {Y}_{2 P}\end{matrix} \qquad ( 2 )$$

$$where$$

$$α = ( {X}_{2} - {Y}_{2 P} )$$

### [Mathematical 3]

$$\begin{matrix}{Z}_{3} = \frac{{jX}_{m} ( {Z}_{2} - {jX}_{m} )}{{jX}_{m} + {Z}_{2} - {jX}_{m}} - {jX}_{m} \\ = \frac{{X}_{m}^{2}}{{Z}_{2}} + {jX}_{m} - {jX}_{m} \\ = \frac{{X}_{m}^{2}}{{Z}_{2}}\end{matrix} \qquad ( 3 )$$

### [Mathematical 4]

$$\begin{matrix}Z = {Z}_{3} + {jX}_{1} - {jY}_{1} \\ = \frac{{X}_{m}^{2}}{{Z}_{2}} + {jX}_{1} - {jY}_{1}\end{matrix} \qquad ( 4 )$$

where

ρ=(X₁=Y₁)

### [Mathematical 5]

Thus, let

$$\begin{matrix}Z = \frac{{X}_{m}^{2}}{{Z}_{2}} + {jX}_{1} - {jY}_{1} \\ = {[ \frac{{Z}_{out \_ i + 1} {Y}_{2 P}^{2}}{{Z}_{out \_ i + 1}^{2} + {β}^{2}} + j α - j \{ \frac{( {X}_{2 S} + β ) β}{{Z}_{out \_ i + 1}^{2} + {β}^{2}} \} {Y}_{2 P} ]}^{- 1} {X}_{m}^{2} + j ρ\end{matrix} \qquad ( 5 )$$

$$α = ( {X}_{2} - {Y}_{2 P} ) = 0$$

$$β = ( {X}_{2 S} - {Y}_{2 P} ) = 0 ,$$

$$Z = \frac{{Z}_{out \_ i + 1} {X}_{m}^{2}}{{Y}_{2 P}^{2}} + j ρ \qquad ( 6 )$$

### [Mathematical 6]

Let

ρ=0,

$$Z = \frac{{Z}_{out \_ i + 1} {X}_{m}^{2}}{{Y}_{2 P}^{2}} \qquad ( 7 )$$

### [Mathematical 7]

Also,

Z=Z_{out_i+1}(ωLₘ)²(ωC_{2P})²

$$= \frac{{Z}_{out \_ i + 1} {L}_{m}^{2}}{{C}_{2 P}^{2}} \qquad ( 8 )$$

### [Mathematical 8]

Let

α=(X₂−Y_{2P})=0

$$ω {L}_{2} = \frac{1}{ω {C}_{2 P}} , \qquad ( 9 )$$

$$\begin{matrix}Z = \frac{{{Z}_{out \_ i + 1} ( ω {L}_{m} )}^{2}}{{( ω {L}_{2} )}^{2}} \\ = \frac{{Z}_{out \_ i + 1} {L}_{m}^{2}}{{L}_{2}^{2}} \\ = \frac{{Z}_{out \_ i + 1} {k}^{2} {L}_{1}}{{L}_{2}}\end{matrix}$$

Assuming a transmission efficiency η as 1,

### [Mathematical 9]

ηIᵢₙ Vᵢₙ=Iₒᵤₜ Vₒᵤₜ (10)

The output voltage V_{out_i+1} is obtained as follows.

### [Mathematical 10]

$${V}_{out \_ i + 1} = \frac{{I}_{in}}{{I}_{out}} {V}_{in \_ i} \qquad ( 11 )$$

Here, formulae (12), (13) are substituted into formula (11).

### [Mathematical 11]

$${I}_{in} = \frac{{V}_{in \_ i}}{Z} \qquad ( 12 )$$

$${I}_{out} = \frac{{V}_{out}}{{Z}_{out \_ i + 1}} \qquad ( 13 )$$

### [Mathematical 12]

$${V}_{out \_ i + 1} = \frac{{V}_{in}}{Z} \frac{{Z}_{out \_ i + 1}}{{V}_{out}} {V}_{in \_ i} \qquad ( 14 )$$

$${V}_{out \_ i + 1} = \frac{{V}_{in\_i}}{{k}^{2} \frac{{L}_{1}}{{L}_{2}} {Z}_{out \_ i + 1}} \frac{{Z}_{out \_ i + 1}}{{V}_{out \_ i + 1}} {V}_{in \_ i}$$

$${V}_{out \_ i + 1}^{2} = \frac{1}{{k}^{2}} \frac{{L}_{2}}{{L}_{1}} {V}_{in \_ i}^{2}$$

$${V}_{out \_ i + 1} = \frac{1}{k} \sqrt{\frac{{L}_{2}}{{L}_{1}}} {V}_{in \_ i}$$

From formula (14), it is found that the output voltage V_{out_i+1} does not have load resistance dependency. That is, with respect to the input voltage V_{in_j}, the output voltage V_{out_i+1} is determined by the coupling coefficient and the coil inductances L₁, L₂.

In other words, it is shown that even when a plurality of intermediate power transmitting/receiving devices are connected in a multistage manner, it is theoretically possible to cause voltage at each of the intermediate power transmitting/receiving devices to fall within a fixed range regardless of loads. For example, as shown in the following formula (15), the output voltage Vout can be made equal to the input voltage Vin. This corresponds to the state where “the reciprocal of the coupling coefficient k between the transmitting coil and the receiving coil” and “the square root of the quotient of the inductance value L_{R} (L₂) of the receiving coil divided by the inductance value L_{T} (L₁) of the transmitting coil” are each set to 1.

### [Mathematical 13]

$${V}_{out} = \frac{1}{k} \sqrt{\frac{{L}_{2}}{{L}_{1}}} {V}_{in} = {V}_{in} \qquad ( 15 )$$

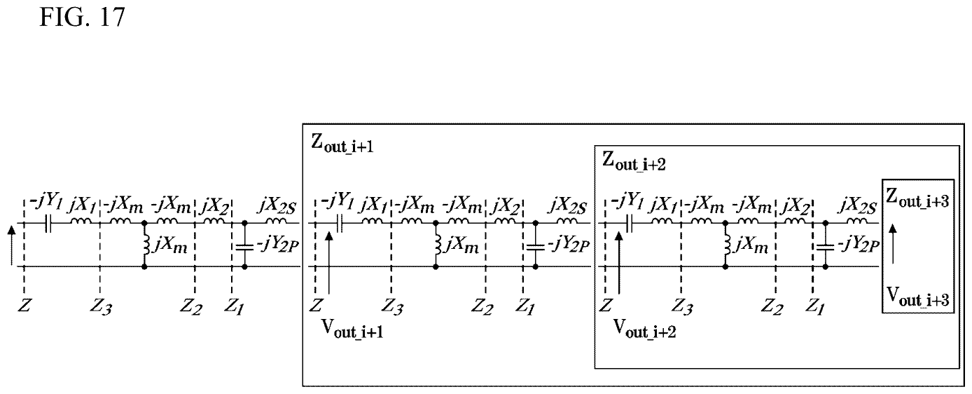

Practically, correction is made such that the output voltage Vout equals the input voltage Vin with the transmission efficiency η element taken into consideration. For example, if the transmission efficiency is around 0.9, “the reciprocal of the coupling coefficient k between the transmitting coil (inductance value L_{T}) and a receiving coil (inductance value L_{R})” and “the square root of the quotient of the inductance value L_{R} of the receiving coil divided by the inductance value L_{T} of the transmitting coil” are each set to around 1.1. FIG. 17 shows voltages and an equivalent circuit diagram in multistage connection. This is equivalent to a state in which the circuit in FIG. 16 which is the equivalent circuit of the circuit in FIG. 15 is connected in a multistage manner. It shows that if the input voltage and the output voltage are equal to each other for a certain intermediate power transmitting/receiving device, the input voltages and the output voltages are equal to each other also among intermediate power transmitting/receiving devices connected at the subsequent stages.

### Embodiment 2

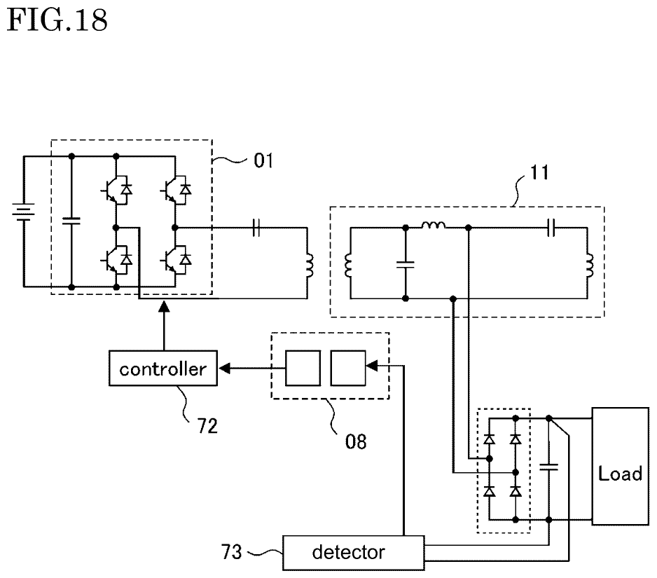

In embodiment 2, as shown in FIG. 18, a wireless communication mechanism 08 is provided between the intermediate power transmitting/receiving device 11 and the AC output power source 01, in addition to embodiment 1. It is noted that, although not shown, the wireless communication mechanism 08 is provided also between the intermediate power transmitting/receiving devices. A voltage detection unit 73 is provided to the intermediate power transmitting/receiving device 11. Voltage detected by the voltage detection unit 73 is transmitted to the wireless communication mechanism 08. The transmitted voltage information is received by the controller 72.

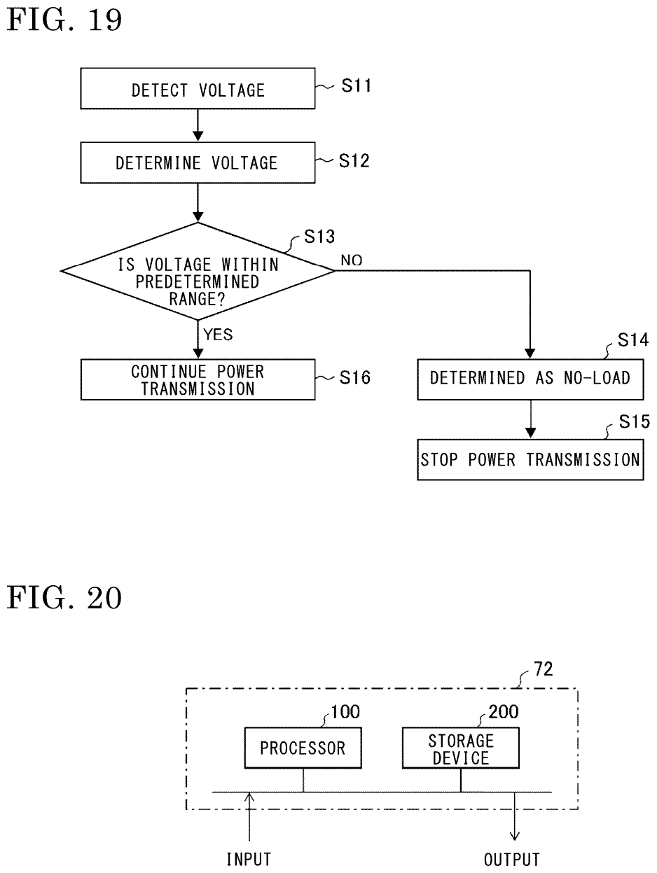

Next, operation will be described with the flowchart in FIG. 19.
(1) Voltage at the voltage detection unit 73 is detected (step S11 in FIG. 19), and the controller 72 performs determination (step S12). If the detected voltage exceeds a predetermined range (step S13, No), the load state is determined to be a no-load or significantly low-load state (step S14), and power supply is stopped (step S15), or an operation such as reducing output voltage is performed.
(2) If the voltage is within the predetermined range (step S13, Yes), power supply is again continuously performed (step S16), and if the voltage is outside the predetermined range, it is determined that the no-load state has been continued, and power supply is stopped (step S15).
(3) Even after the voltage exceeds the predetermined range, power supply is performed at a predetermined timing. If the voltage is within the predetermined range (step S13, Yes), power supply is again continuously performed (step S16), and if the voltage is outside the predetermined range, it is determined that the no-load state has been continued, and power supply is not performed (step S15).

Such a configuration according to embodiment 2 makes it unnecessary to detect the phase difference between current and voltage. Also in this configuration, it is not necessary to strictly manage voltages at all the intermediate power transmitting/receiving devices, and it suffices that output voltage of any one of the intermediate power transmitting/receiving devices is detected. In a configuration in which wireless power supply devices are connected in a multistage manner, some kind of communication modules may be mounted between devices according to applications. In such a case, the present embodiment has superiority in being capable of directly detecting and controlling the voltage value without requiring an additional configuration.

FIG. 20 shows one example of hardware of a microcomputer in the controller 72. The controller 72 is composed of a processor 100 and a storage device 200, and, although not shown, the storage device is equipped with a volatile storage device such as a random access memory and a nonvolatile auxiliary storage device such as a flash memory. The controller 72 may be equipped with a hard-disk auxiliary storage device instead of the flash memory. The processor 100 executes a program inputted from the storage device 200, whereby the control in the no-load state aforementioned in FIG. 11 and FIG. 19 is performed. In this case, the program is inputted into the processor 100 from the auxiliary storage device via the volatile storage device. The processor 100 may output data such as a calculation result to the volatile storage device of the storage device 200 or may store the data in the auxiliary storage device via the volatile storage device.

Although the disclosure is described above in terms of various exemplary embodiments and implementations, it should be understood that the various features, aspects, and functionality described in one or more of the individual embodiments are not limited in their applicability to the particular embodiment with which they are described, but instead can be applied, alone or in various combinations to one or more of the embodiments of the disclosure.

It is therefore understood that numerous modifications which have not been exemplified can be devised without departing from the scope of the present disclosure. For example, at least one of the constituent components may be modified, added, or eliminated. At least one of the constituent components mentioned in at least one of the preferred embodiments may be selected and combined with the constituent components mentioned in another preferred embodiment.

### DESCRIPTION OF THE REFERENCE CHARACTERS

01 AC output power source
02 resonance module
03 first transmitting coil
08 wireless communication mechanism
11, 12 intermediate power transmitting/receiving device
21, 22 load device
71 current detection unit
72 controller
73 voltage detection unit
100 processor
101 receiving coil
102 voltage control module
103 resonance capacitor
104 transmitting coil
200 storage device
201 diode bridge
202 capacitor
203 load

1.-7. (canceled)

8. A wireless power supply device comprising a plurality of intermediate power transmitting/receiving devices which receive power and supply the received power to connected loads devices and which each transmit power to a next one of the power transmitting/receiving devices wherein each of the load devices has a rectifier and a load,
each of the plurality of intermediate power transmitting/receiving devices has
a power receiving device which has a receiving coil and is for receiving power,
a power transmitting device which has a transmitting coil and a resonance capacitor connected in series to each other and is capable of transmitting power,
a capacitor connected in parallel to the power receiving device, and
an inductor having one terminal connected to the capacitor and another terminal connected to the power transmitting device and the load device, the inductor being connected in series to parallel connection of the capacitor and the receiving coil, and connected in series to the resonance capacitor, and
output voltage of a first intermediate power transmitting/receiving device has a value obtained by multiplying a reciprocal of a coupling coefficient between the transmitting coil of the first intermediate power transmitting/receiving device and the receiving coil of a second intermediate power transmitting/receiving device at a stage subsequent to the first intermediate power transmitting/receiving device, by a square root of a quotient of an inductance of the receiving coil divided by an inductance of the transmitting coil, and then further multiplying a resultant product by input voltage of the second intermediate power transmitting/receiving device, and an inductance value of the inductor and an inductance value of the receiving coil are set to be the same value, thus causing voltage at each of the intermediate power transmitting/receiving devices to fall within a fixed range.

9. The wireless power supply device according to claim 8, wherein the output voltage of the first intermediate power transmitting/receiving device is equal to the input voltage of the second intermediate power transmitting/receiving device.

10. The wireless power supply device according to claim 8, wherein
the transmitting coil (104), the resonance capacitor (103), the receiving coil (101), the capacitor, and the inductor are each configured such that the first resonant frequency between the transmitting coil (104) and the resonance capacitor (103), the second resonant frequency between the receiving coil (101) and the capacitor, and the third resonant frequency between the inductor and the capacitor match each other.

11. The wireless power supply device according to claim 8, further comprising a power transmitting device which is connected to a power source and transmits power to one of the plurality of intermediate power transmitting/receiving devices, wherein
the power transmitting device connected to the power source has a detector to detect a phase difference between output voltage and output current, and
when a detected phase difference is outside a predetermined range, power transmission from the power source is stopped.

12. The wireless power supply device according to claim 8, further comprising:
a power transmitting device which is connected to a power source and transmits power to one of the plurality of intermediate power transmitting/receiving devices; and
a detector to detect voltage at the intermediate power transmitting/receiving device or at the load, wherein
when detected voltage is outside a predetermined range, power transmission from the power source is stopped.

13. The wireless power supply device according to claim 11, wherein
control for stopping power transmission from the power source is performed by a controller.

14. The wireless power supply device according to claim 8, wherein
the intermediate power transmitting/receiving device at a final stage of the plurality of intermediate power transmitting/receiving devices is provided with a configuration for preventing power transmission to a subsequent stage.

15. The wireless power supply device according to claim 9, further comprising a power transmitting device which is connected to a power source and transmits power to one of the plurality of intermediate power transmitting/receiving devices, wherein
the power transmitting device connected to the power source has a detector to detect a phase difference between output voltage and output current, and
when a detected phase difference is outside a predetermined range, power transmission from the power source is stopped.

16. The wireless power supply device according to claim 10, further comprising a power transmitting device which is connected to a power source and transmits power to one of the plurality of intermediate power transmitting/receiving devices, wherein
the power transmitting device connected to the power source has a detector to detect a phase difference between output voltage and output current, and
when a detected phase difference is outside a predetermined range, power transmission from the power source is stopped.

17. The wireless power supply device according to claim 9, further comprising:
a power transmitting device which is connected to a power source and transmits power to one of the plurality of intermediate power transmitting/receiving devices; and
a detector to detect voltage at the intermediate power transmitting/receiving device or at the load, wherein
when detected voltage is outside a predetermined range, power transmission from the power source is stopped.

18. The wireless power supply device according to claim 10, further comprising:
a power transmitting device which is connected to a power source and transmits power to one of the plurality of intermediate power transmitting/receiving devices; and
a detector to detect voltage at the intermediate power transmitting/receiving device or at the load, wherein
when detected voltage is outside a predetermined range, power transmission from the power source is stopped.

19. The wireless power supply device according to claim 15, wherein
control for stopping power transmission from the power source is performed by a controller.

20. The wireless power supply device according to claim 16, wherein
control for stopping power transmission from the power source is performed by a controller.

21. The wireless power supply device according to claim 9, wherein
the intermediate power transmitting/receiving device at a final stage of the plurality of intermediate power transmitting/receiving devices is provided with a configuration for preventing power transmission to a subsequent stage.

22. The wireless power supply device according to claim 10, wherein
the intermediate power transmitting/receiving device at a final stage of the plurality of intermediate power transmitting/receiving devices is provided with a configuration for preventing power transmission to a subsequent stage.
